(19) United States
(12) Patent Application Publication
(10) Pub. No.: US 2026/0290033 A1
(43) Pub. Date: Sep. 24, 2026

(54) SYSTEM FOR RECOGNIZING OBJECT BASED ON SELF-SUPERVISED LEARNING OF ARTIFICIAL INTELLIGENCE AND METHOD IMPLEMENTING THE SAME

(71) Applicants: HYUNDAI MOTOR COMPANY, Seoul (KR); Kia Corporation, Seoul (KR)

(72) Inventor: Jin Ho PARK, Gyeonggido (KR)

(21) Appl. No.: 19/414,540

(22) Filed: Dec. 10, 2025

(30) Foreign Application Priority Data
Mar. 24, 2025 (KR) 10-2025-0037539

(51) Int. Cl. G06V 20/58; G06V 10/75; G06V 10/762; G06V 10/764; G06V 10/776; G06V 10/80; G06V 10/82; G06V 10/774

(52) U.S. Cl. CPC G06V 20/58; G06V 10/757; G06V 10/763; G06V 10/764; G06V 10/776; G06V 10/809; G06V 10/82; G06V 10/7753

(57) ABSTRACT

An artificial intelligence (AI)-based system and a method for recognizing an object based on at least one autonomous driving sensor. The system includes a processor and memory storing instructions that, when executed, perform operations including obtaining point cloud data from the at least one autonomous driving sensor and clustering the point cloud data into a cluster of points, extracting a latent feature from an image obtained from the at least one autonomous driving sensor, based on a result of a self-supervised learning process, and assigning a matching class to the cluster of points, and generating a pseudo GT bounding box for the cluster of points based on the matching class.

### CROSS-REFERENCE TO RELATED APPLICATION

Pursuant to 35 U.S.C. § 119(a), this application claims the benefit of an earlier filing date and right of priority to Korean Patent Application No. 10-2025-0037539, filed in the Korean Intellectual Property Office on Mar. 24, 2025, the entire contents of which are incorporated herein by reference.

### TECHNICAL FIELD

The present disclosure relates to a system and a method for recognizing an object based on artificial intelligence (AI) self-supervised learning.

### BACKGROUND

With the recent development and commercialization of autonomous vehicles, a variety of sensors and artificial intelligence (AI) technologies are increasingly being used to support an autonomous driving function of a vehicle. For example, research on an object in front of a moving vehicle, a distance between the object and the vehicle, and an algorithm in which the vehicle responds to specific situations to ensure safety is ongoing.

Accordingly, a vehicle sensor technology is becoming advanced, and high-performance sensors such as Light Detection and Ranging (LiDAR) that recognizes surrounding environments by using laser beams, Radio Detection and Ranging (RADAR) that uses radio waves, an ultrasonic sensor, a fisheye camera capable of capturing 360-degree images, a multifocal lens, and a global positioning system (GPS) are being installed in vehicles.

As such, a super sensor vehicle may be implemented by aggregating measurement results obtained from a plurality of sensors. In self-driving (autonomous driving), the concept of a super sensor refers to a technology that accurately recognizes surrounding environments for comfort or safety by combining measured values from a variety of sensors rather than relying on individual sensors. Here, with the addition of information and communications technology (ICT) and cloud technology, sensors required for autonomous driving, and AI algorithms related thereto are becoming more sophisticated than ever, to increase the reliability of the determination of vehicle sensors by remotely accumulating data from numerous fleets of vehicles without targeting only a single vehicle and training an AI server and a database.

However, to build a safe autonomous driving environment, efforts are ongoing to improve the accuracy of object recognition using an AI module and an autonomous driving sensor such as a LiDAR.

### SUMMARY

According to an aspect of the present disclosure, an artificial intelligence (AI)-based system for recognizing an object by using at least one autonomous driving sensor includes a processor and memory storing instructions that, when executed, perform operations including obtaining point cloud data from the at least one autonomous driving sensor and clustering the point cloud data into a cluster of points, extracting a latent feature from an image obtained from the at least one autonomous driving sensor based on a result of self-supervised learning, assigning a matching class to the cluster of points, and generating a pseudo GT bounding box for the cluster of points based on the matching class.

According to the second aspect of the present disclosure, in the system for recognizing an object, the autonomous driving sensor includes at least one LiDAR and a camera.

According to the third aspect of the present disclosure, in the system for recognizing an object, the self-supervised learning includes a primary learning process of encoding a training image through an encoder to convert the training image into the latent feature and reconstructing an image similar to the training image in a decoder.

According to the fourth aspect of the present disclosure, in the system for recognizing an object, the encoder includes a teacher encoder and a student encoder, and a knowledge distillation (KD) loss function is applied such that an output of the student encoder is similar to an output of the teacher encoder.

According to the fifth aspect of the present disclosure, in the system for recognizing an object, at least one of a L2 loss function including a variational auto encoder (VAE), a similarity-based loss function, or a Generative Adversarial Nets (GAN) loss function, to which a discriminator is applied, is adopted as a loss function for the primary learning process of reconstructing the image.

According to the sixth aspect of the present disclosure, in the system for recognizing an object, there is no label related to a GT bounding box in the image input from the autonomous driving sensor.

According to the seventh aspect of the present disclosure, in the system for recognizing an object, the operations further include performing a secondary learning process including K-Means clustering and contrastive learning to enhance discrimination power of the latent feature, in parallel with the primary learning process.

According to the eighth aspect of the present disclosure, in the system for recognizing an object, the K-Means clustering is executed periodically and is updated.

According to the ninth aspect of the present disclosure, in the system for recognizing an object, the matching class is determined by using a K-Means vector that is most similar to the latent feature.

According to the tenth aspect of the present disclosure, in the system for recognizing an object, the operations further include assigning temporary classes to points in the cluster of points by using an external or internal parameter of the LiDAR and a camera, and then determining a temporary class which is assigned to the most points in the cluster of points, as the matching class.

According to an aspect of the present disclosure, a method for performing artificial intelligence (AI)-based objection recognition using at least one autonomous driving sensor includes obtaining point cloud data and clustering the point cloud data into a cluster of points, extracting a latent feature from an image obtained from the autonomous driving sensor, based on a result of self-supervised learning, assigning a matching class to a cluster of points, and generating a pseudo GT bounding box for the cluster of points based on the matching class.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing an example of the overall system for automatically recognizing an object and controlling a vehicle for the purpose of autonomous driving, according to an implementation of the present disclosure;

FIG. 2 is a block diagram showing an example of an overall algorithm for labeling unlabeled point cloud data and generating a pseudo GT bounding box including class information, according to an implementation of the present disclosure; and

FIG. 3 is a block diagram showing an example of a computing system for autonomous vehicle control and object recognition operations, according to an implementation of the present disclosure.

### DETAILED DESCRIPTION

Implementations of the present disclosure can provide a system and a method for recognizing an object based on AI self-supervised learning. In some implementations, a system and a method are provided for recognizing an object based on AI self-supervised learning that enables smooth object recognition even for a point cloud which does not receive a label for AI object recognition.

Implementations of the present disclosure can generate a ground truth (GT) bounding box for recognizing a pseudo object for unlabeled point clouds, by using a clustering technique and a feature obtained through AI self-supervised learning.

In general, technologies for recognizing/detecting an object are important for safe autonomous driving. Unlike two-dimensional (2D) object recognition performed with a camera-based technology, in the case of three-dimensional (3D) object recognition, technologies can be implemented using various sensors such as cameras, LiDAR, and radar. Moreover, providing useful information is becoming increasingly important for the safety of autonomous driving compared to 2D recognition.

In some scenarios of 3D object recognition, an AI object recognition network can be applied in a supervised learning method. In such scenarios, a person may need to directly create a GT bounding box as a kind of annotation in a learning target image by using use a specific tool on raw data of a point cloud. Furthermore, to generalize the performance of an object recognition model, pieces of GT information may be needed to recognize objects of various classes in various situations.

Manual assignment of GT information can have benefits of low error probability in the GT bounding box. However, the GT generation speed can be very slow and the creating a GT generation cost per frame may not be efficient. Furthermore, there may be variability and errors according to individual differences in GT manual work.

Another technique is to utilize pseudo-GT using Large Object Detection (LOD) (large learning model) models. Such techniques can have benefits such as fast GT generation speed and low GT generation cost. However, there may arise problems with the reliability of inference results of the model. To train a large model with high generalization performance, a considerable amount of GT may be needed anyway. For example, when an autonomous driving algorithm based on a point cloud input is built, the generalization performance for recognizing an object may not be very high, for example in situations where LiDAR sensor data is diverse.

Yet another technique is to utilize an object recognizing technique including clustering, which is a knowledge-based method. Such techniques can be used even in situations where there is no GT data at all. However, such techniques can suffer from large variations in performance depending on clusters and parameter tuning of an algorithm, and can require human supervision, e.g., to utilize patterns in advance for the purpose of classifying an object corresponding to each cluster.

According to implementations of the present disclosure, one or more problems described above can be addressed by an algorithm that generates a pseudo 3D GT bounding box for a plurality of unlabeled point cloud portions, among point cloud data obtained from an autonomous driving sensor. The GT bounding box can include class classification information about an object.

In some implementations, the algorithm uses both a synchronized image and a point cloud to apply labels to unlabeled data. For example, implementations of the present disclosure can extract features from an image by using AI self-supervised learning techniques to implement the algorithm. In addition, the algorithm can apply clustering and contrastive learning techniques to the features, and enhance object discrimination based on the features extracted from the image.

Furthermore, some implementations can additionally apply techniques such as distillation of non-contrastive Image representations (DINO) approach and vector quantization to enhance or strengthen the features of the extracted image.

Specifically, implementations of the present disclosure can generate a mapping table for mapping between features and classes by using cluster information of image features extracted by a trained image encoder, and assign point classes by projecting a point cloud onto an image plane. Moreover, a rule-based clustering method can be used to generate the aforementioned pseudo GT bounding box.

Implementations disclosed herein can address technical challenges that are not limited to the technical challenges mentioned above, and other technical challenges not expressly mentioned will be apparent to those skilled in the art from the detailed description of the present disclosure and the accompanying drawings.

Hereinafter, some implementations of the present disclosure will be described in detail with reference to the accompanying drawings. In adding reference numerals to components of each drawing, it should be noted that the same components include the same reference numerals, although they are indicated on another drawing. Furthermore, in describing the implementations of the present disclosure, detailed descriptions associated with well-known functions or configurations will be omitted when they may make subject matters of the present disclosure unnecessarily obscure.

In describing elements of an implementation of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

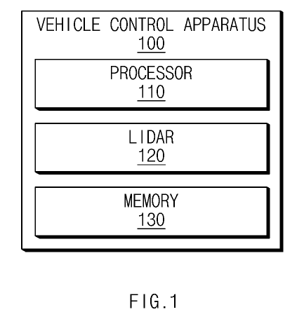

FIG. 1 is a block diagram showing an example of the overall system for automatically recognizing an object and controlling a vehicle for the purpose of autonomous driving, according to an implementation of the present disclosure.

Referring to FIG. 1, a vehicle control apparatus 100 according to an implementation of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection technique. For example, the vehicle control apparatus 100 may further include components not shown in FIG. 1.

The vehicle control apparatus 100 according to an implementation may include a processor 110, a sensor 120 such as LiDAR, and a memory 130. The processor 110, the sensor 120, or the memory 130 may be electronically and/or operably coupled with each other by an electronical component including a communication bus.

Hereinafter, the pieces of hardware coupled operably may include direct and/or indirect connection between pieces of hardware is established by wired and/or wirelessly such that second hardware is controlled by first hardware among the pieces of hardware.

Although different blocks are shown in FIG. 1, implementations are not limited thereto. For example, some of the pieces of hardware in FIG. 1 may be included in a single integrated circuit including a system on chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an implementation may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may include the architecture of a single-core processor, or may include the architecture of a multi-core processor including a dual core, a quad core, a hexa core, or an octa core.

According to an implementation, the processor 110 may include at least one of a graphic processing unit (GPU), or a neural processing unit (NPU), or any combination thereof. For example, the GPU may be referred to as a “visual processing unit (VPU)”. For example, the NPU may be referred to as a “neural network processing unit”.

The vehicle control apparatus 100 according to an implementation may include a sensor 120, such as a depth sensor for detecting an external object. For example, the sensor 120 for detecting an external object may include at least one of a time of flight (ToF) sensor, the LiDAR 120, a structured light sensor, an ultrasonic sensor, an infrared sensor, radio detection and ranging (RADAR), or an optical distance sensor, or any combination thereof. Hereinafter, for convenience of description, descriptions will focus on the sensor 120 implemented as LiDAR, but implementations are not limited thereto.

The vehicle control apparatus 100 according to an implementation may include the LiDAR sensor 120 (or simply referred to as LiDAR 120) that obtains a plurality of points based on a pulse laser signal. For example, the LiDAR 120 may obtain datasets obtained by identifying objects around the vehicle control apparatus 100 (or a vehicle including the vehicle control apparatus 100). For example, the LiDAR 120 may identify at least one of a location of the surrounding object, a movement direction of the surrounding object, or the speed of the surrounding object, or any combination thereof based on the pulse laser signal emitted from the LiDAR 120 being reflected and returned by the surrounding object.

For example, the LiDAR 120 may obtain datasets for expressing an external object in the space defined by an x-axis, a y-axis, and a z-axis based on a pulse laser signal reflected from surrounding objects. For example, the LiDAR 120 may obtain datasets including a plurality of points in the space, which is formed by the x-axis, the y-axis, and the z-axis, based on receiving the pulse laser signal at a designated period. For example, the plurality of points may include points representing an external object within a three-dimensional virtual coordinate system. The three-dimensional virtual coordinate system may include at least one of a vehicle coordinate system, or a LiDAR coordinate system, or any combination thereof. However, an example of the three-dimensional virtual coordinate system is not limited to those described above.

The memory 130 of the vehicle control apparatus 100 according to an implementation may include a hardware component for storing data and/or instructions that are to be input and/or output to the processor 110 of the vehicle control apparatus 100. For example, the memory 130 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

One or more instructions indicating an arithmetic operation and/or an operation to be performed on data by the processor 110 of the vehicle control apparatus 100 may be stored in the memory 130 of the vehicle control apparatus 100. A set of one or more instructions may be referred to as a “program”, “firmware”, an “operating system”, a “process”, a “routine”, a “sub-routine”, and/or an “application”.

Hereinafter, the fact that an application is installed in the vehicle control apparatus 100 may mean that the one or more instructions provided in a form of an application are stored in the memory 130, and may mean that one or more applications are stored in a format (e.g., a file with an extension specified by the operating system of the vehicle control apparatus 100) executable by the processor 110 of the vehicle control apparatus 100.

For example, the memory 130 may include a first neural network model for detecting an object. For example, the memory 130 may include a second neural network model for outputting the types of the plurality of points obtained by the LiDAR 120, and/or scores of the plurality of points.

In an implementation, the processor 110 may obtain at least one of a first virtual box representing a target object, or a first class representing the type of the target object, or any combination thereof based on the plurality of points obtained through the LiDAR 120 and the first neural network model stored in the memory 130.

For example, the processor 110 may obtain at least one of the first virtual box representing the target object, or the first class representing the type of the target object, or any combination thereof based on inputting the plurality of points to the first neural network model. For example, the first neural network model may include an object detection model. For example, the target object may include an external object placed within a specified distance from the vehicle control apparatus 100 (or a host vehicle including the vehicle control apparatus 100). For example, the target object may include an object that is identified by the vehicle control apparatus 100 and is tracked, e.g., continuously tracked. For example, the type of the target object may include one or more of a plurality of types for classifying the target object. For example, the type of the target object may include at least one of a first type representing the ground, or a second type representing a type different from the ground, or any combination thereof. The type of the target object is not limited to the examples described above. For example, the type of the target object may include, but is not limited to, at least one of a third type representing a person, or a fourth type representing a vehicle, or any combination thereof.

In an implementation, the processor 110 may obtain at least one of first partial points corresponding to at least part of the target object among the plurality of points, or a second class identified by the first partial points and representing the type of the target object, or any combination thereof based on the plurality of points and a second neural network model. For example, the second neural network model may include a segmentation model.

For example, the second neural network model may include a neural network model for obtaining the types of the plurality of points and scores of the plurality of points.

For example, the processor 110 may obtain the first partial points corresponding to at least part of the target object among the plurality of points based on inputting the plurality of points to the second neural network model. For example, the processor 110 may identify the types of the plurality of points based on inputting the plurality of points to the second neural network model. For example, the processor 110 may obtain the first partial points corresponding to at least part of the target object among the plurality of points based on the type of each of the plurality of points.

In an implementation, the processor 110 may perform a first specified algorithm on the plurality of points. For example, the processor 110 may perform the first specified algorithm for classifying the type of each of the plurality of points on the plurality of points. For example, the processor 110 may classify second partial points corresponding to a specified type among the plurality of points. For example, the specified type may include a type representing the ground.

For example, on the basis of performing the first specified algorithm on the plurality of points, the processor 110 may obtain (or identify) the first partial points by classifying the second partial points corresponding to the specified type and excluding the second partial points from the plurality of points.

In an implementation, the processor 110 may obtain at least one of a partial class for obtaining the second class, or a score of each of the plurality of points, or any combination thereof based on inputting the plurality of points to the second neural network model. For example, the processor 110 may obtain the partial class and the score of each of the plurality of points based on inputting the plurality of points to the second neural network model. For example, the partial class may include classifying the plurality of points based on an arbitrary type.

For example, the processor 110 may fuse the partial class, the score of each of the plurality of points, and the second partial points. For example, the processor 110 may perform clustering based on fusing the partial class, the score of each of the plurality of points, and the second partial points. For example, the clustering may include grouping the first partial points corresponding to at least part of the target object.

For example, the processor 110 may obtain a point cloud for generating a second virtual box based on the first partial points. For example, the processor 110 may obtain the point cloud based on grouping the first partial points.

For example, the processor 110 may generate the second virtual box, which is different from the first virtual box and represents the target object, based on the point cloud. For example, the second virtual box may include a box including at least some of the first partial points.

For example, the processor 110 may identify a heading direction indicating a traveling direction of the target object based on at least one of the first partial points, or the point cloud, or any combination thereof.

For example, the processor 110 may identify the location of the second virtual box in the virtual coordinate system based on at least one of the first partial points, or the point cloud, or any combination thereof. For example, the processor 110 may identify the size of the second virtual box based on at least one of the first partial points, or the point cloud, or any combination thereof. For example, the processor 110 may identify the second class based on at least one of the first partial points, or the point cloud, or any combination thereof. For example, the processor 110 may identify at least one of a heading direction indicating a traveling direction of the target object, a location of a second virtual box in a virtual coordinate system, a size of the second virtual box, or a second class, or any combination thereof based on at least one of the first partial points, or the point cloud, or any combination thereof. For example, the processor 110 may identify the heading direction of a bounding box based on at least one of the first virtual box, the first class, the heading direction of the second virtual box, the location of the second virtual box, the size of the second virtual box, or the second class, or any combination thereof. For example, the processor 110 may identify the location of a bounding box in a virtual coordinate system based on at least one of the first virtual box, the first class, the heading direction of the second virtual box, the location of the second virtual box, the size of the second virtual box, or the second class, or any combination thereof. For example, the processor 110 may obtain a third class representing the type of the target object corresponding to the bounding box based on at least one of the first virtual box, the first class, the heading direction of the second virtual box, the location of the second virtual box, the size of the second virtual box, or the second class, or any combination thereof. For example, the processor 110 may obtain at least one of the heading direction of the bounding box, the location of the bounding box in the virtual coordinate system, or the third class indicating the type of the target object corresponding to the bounding box, or any combination thereof based on at least one of the first virtual box, the first class, the heading direction of the second virtual box, the location of the second virtual box, the size of the second virtual box, or the second class, or any combination thereof.

For example, the processor 110 may assign a first identifier to the second virtual box for tracking the second virtual box. For example, the processor 110 may assign, to a bounding box, a second identifier corresponding to the first identifier.

For example, the processor 110 may track the bounding box by using the second identifier. For example, the processor 110 may track a target object based on identifying, in a plurality of frames, a plurality of bounding boxes including the bounding box to which the second identifier is assigned. For example, in scenarios where the second identifier is an identifier assigned to the bounding box corresponding to the target object, the processor 110 may track the target object by identifying a plurality of bounding boxes, to which the second identifier is assigned, in a plurality of frames.

In an implementation, the processor 110 may output the bounding box corresponding to the target object based on at least one of the first virtual box, the first class, the first partial points, or the second class, or any combination thereof. For example, a bounding box may include an example of the target object expressed in a virtual coordinate system in the form of a hexahedron.

Hereinafter, operations performed by a CPU, a GPU, and/or an NPU included in the processor 110 are briefly described.

In an implementation, the processor 110 may include at least one of the CPU, the GPU, or the NPU, or any combination thereof. For example, at least one of the GPU, or the NPU, or any combination thereof may obtain the first virtual box and the first class based on the first neural network model. For example, at least one of the GPU or the NPU may obtain the first virtual box and the first class. For example, at least one of the GPU, or the NPU, or any combination thereof may obtain a score for each of the plurality of points and a partial class for obtaining the second class based on the second neural network model. For example, at least one of the GPU or the NPU may obtain the score of each of the plurality of points and the partial class for obtaining the second class based on the second neural network model. For example, the CPU may classify the second partial points corresponding to a specified type among the plurality of points based on performing the first specified algorithm for classifying each type of the plurality of points.

As described above, the vehicle control apparatus 100 according to an implementation may include at least one processor 110. The vehicle control apparatus 100 may accurately detect the target object by detecting the target object by using the at least one processor 110. Furthermore, the vehicle control apparatus 100 may reduce the load on each processor by performing parallel processes.

Object recognition is described next, including examples based on specific scenarios of AI object recognition according to an implementation of the present disclosure, related to LiDAR-based object recognition.

In some implementations, the object recognition process can include three stages: pre-processing, segmentation, and tracking.

Pre-processing can be performed by the object recognition system 1000, for example, before executing an object recognition function. The pre-processing may include an operation of removing points forming the ground based on laser sensing data (i.e., raw data not processed) input from the LiDAR 120. Because the laser beam reflected from the ground may be misrecognized as though there is an object on the ground, a process of distinguishing between the ground and non-ground may be performed in the pre-processing stage. In some scenarios, the process may also be performed in the segmentation stage.

For example, in AI object recognition, the pre-processing can implement a process in which an image processing tool of the AI module in the processor 110 removes noise from a LiDAR point cloud image and reduces the total number of points being present in the LiDAR point cloud image, e.g., through a voxel downsampling technique to improve computational efficiency.

In some scenarios, the LiDAR point cloud image may also be displayed in a bird’s eye view (BEV) mode. When a LiDAR map is created to resemble the scene as seen through a bird’s eye when a bird watches a city center while a bird flies overhead, the LiDAR map is called a BEV image.

In some implementations, as described above, the LiDAR 120 generates a point for each of the numerous laser signals and calculates a distance to the point, by sending a laser beam out into environments and recording the round-trip time for the laser beam to be reflected from an object outside the environments and return. The processor 110 may create a real-time LiDAR map of the surrounding environment as a BEV-type 3D map, or as a 2D map in some scenarios, by repeatedly transmitting numerous laser beams in this way.

The lines or areas that appear in black and white on a LiDAR point cloud map can be composed of a large number of points (where each of the points is generated based on the laser beam of the LiDAR 120), in which case the LiDAR sensing image is also called the LiDAR point cloud image. In some implementations, when an RGB-D (Red, Green, Blue – Depth) sensor and a LiDAR sensor are combined, the LiDAR point cloud image may be reconstructed in color.

In general, it can be difficult for humans to perceive objects based on only a few points in the LiDAR point cloud image. However, when comprehensively looking at a point cloud from a BEV perspective or in a two-dimensional plan, a human viewer can obtain an approximate understanding of the surroundings of the vehicle. Furthermore, for example, objects such as vehicles, buses, pedestrians, street trees, traffic signs, and other objects that are present in the LiDAR point cloud image may be recognized. Each object may be classified into classes belonging to a group with specific characteristics, such as a vehicle class or a bus class or the like.

Machine-learning networks, such as an AI deep neural network can be implemented to identify a class of an object such as a vehicle class, a bus class, and the like in the LiDAR point cloud image. In many cases, to identify objects in the LiDAR point cloud image through an AI neural network and to identify classes of the objects, AI training can be performed on the AI neural network.

The AI training of an neural network can be performed utilizing datasets. For example, a dataset called PANDASET^{™} (source: https://pandaset.org/#data-collection) includes over 48,000 camera images (mostly taken in the Silicon Valley area in the United States) and over 16,000 LiDAR scan images, which are annotated with 28 classes, including pedestrians, passenger cars, bicycles, construction site signs, and traffic signs.

Moreover, the LiDAR point cloud image may be visualized to suit a user’s desired options by using point cloud task tools such as Open3D™ (source: https://www.open3d.org/). Because the LiDAR 120 is capable of detecting a distance, 3D LiDAR images may be realistically reproduced in visual processing with Open3D^{™}, for example, in a method in which objects farther away are colored in dark blue, and objects closer are colored in light blue.

Furthermore, as discussed above, in some implementations, the original LiDAR image (i.e., raw data) may be pre-processed by applying a technique called voxel (three-dimensional pixel) downsampling to the LiDAR point cloud image. Here, the voxel can be a cube-shaped 3D pixel. The voxel downsampling is a technique for reducing the number of points in the LiDAR point cloud without requiring excessive AI computation while the structure of the various objects in the cloud is preserved.

In some implementations, for example, the LiDAR 120 emits ‘m’ laser beams ‘n’ times during one scan cycle. In this case, scan values of the laser beams that reflect off an external object can be collectively represented as an m×n matrix. Data of the m×n matrix is called a range image. Each point constituting the LiDAR point cloud image can include, for example, depth (i.e., range) information, and also includes the intensity, azimuth, and inclination of the returned laser pulse and other additional information. For range images, AI training can be performed by using large datasets such as Waymo™ Open Dataset (WOD), for example.

A range view (RV) is a technique that can convert a three-dimensional point cloud into a two- to two-and-a-half-dimensional scene, and represents the converted result as a LiDAR three-dimensional map that a human is capable of intuitively understanding like an analog painting instead of numerous dots. In the range view image, the 3D LiDAR point cloud image includes 2D coordinates. However, the 3D laser-related information (e.g., an angle, an inclination, intensity, or the like) recorded when the range image is obtained is not discarded. When one coordinate of one 2D axis is obtained by applying a variable of a width to coordinates (x, y) among coordinates (x, y, z) of the 3D LiDAR image, and the other coordinate of the other 2D axis is obtained by applying a variable of a height and range image information indicating a range (depth) to coordinate (z), a 2D range view image is created.

In addition, the AI algorithm according to an implementation of the present disclosure may utilize a convolutional neural network (CNN). The CNN can be utilized for AI training to extract features (or feature points) from image data. For example, the AI training can utilize datasets composed of tens of thousands of images. In some implementations, the CNN is capable of processing images from 1D to 3D. As such, the results of a range view image processing tool can be trained by the CNN to perform a function of helping AI accurately recognize an object in an image.

In scenarios where an object around an autonomous vehicle is recognized through machine-learning techniques, an operation of creating a ground truth (GT) bounding box on the aforementioned LiDAR map is also an important process in object recognition. In machine learning, the GT is a term used to indicate an original value or an actual value of data to be trained by the AI. It may be a type of image annotation applied to the LiDAR point cloud image, for example, as a bounding box usually with a box-shaped boundary.

To perform object recognition, the AI module can obtain a label and group various objects. In some implementations, an interval or spacing between 3D data points used to output a GT bounding box may also be set. For example, the spacing can be configured so that one GT bounding box is set to include 50 to 1000 LiDAR cloud points.

In some scenarios, such GT annotations are not present in raw data captured by a sensor such as the LiDAR 120 while a vehicle is driving. In such scenarios, the processor 110 can perform recognition of a target belonging to various classes such as road signs, crosswalks, pedestrians, another vehicle, and a center line as an object. The GT annotation can involve measuring object recognition errors by comparing the object determination results recognized by the AI algorithm of the processor 110 with an actual object and, in some scenarios, to evaluate AI performance. The GT bounding box applied to an original image in an annotation form may be set manually by a user, or may be set by utilizing GT calculation tools, such as grid-striding.

AI object recognition can also utilize predicted bounding boxes. A predicted bounding box can represent a result recognized by the processor 110 as an object of a specific class from the original image data obtained from the LiDAR sensor 120. The predicted bounding box can be displayed in the shape of another bounding box similar to the GT bounding box. The predicted bounding boxes, unlike GT bounding boxes, are the computational results of autonomous driving AI. The predicted bounding box may match the GT bounding box, or may partially overlap the GT bounding box, or may not overlap the GT bounding box at all.

In general, the predicted bounding boxes may not enable definitively determining whether an object of a specific class is actually present at a specific location. As such, the predicted bounding boxes are usually called probability boxes (P-Boxes).

Segmentation processing can be performed after pre-processing. Segmentation can result in, for example, displaying a specific part of a road (e.g., a traffic light) in red and the rest (an asphalt road) in blue. Clustering a point cloud into specific groups and generating P-Box may be performed at the segmentation stage. In some implementations, a technique called cluster expansion can also be utilized. In such scenarios, an expansion target may include a cluster that is expanded to include all points within a given distance from the seed point plus an additional incremental distance epsilon (where the given distance constitutes the unexpanded cluster).

During the segmentation processing, P-Box creation and clustering based on the point cloud can be performed. For example, the AI network performing segmentation can be used to obtain a point label from the LiDAR sensor 120.

In some implementations, to solve a ground recognition error occurring during the segmentation, a “rule-based” ground recognition and label fusion technique can be used. The ground recognition algorithm can include any of various techniques such as slope-based ground recognition, grid-based ground recognition, or other non-planar-based ground recognition. For example, in an implementation of the present disclosure, the slope-based ground recognition technique can be adopted when the ground inside a tunnel is recognized.

For reference, semantic segmentation can involve assigning a unique class label to each point in the point cloud generated by the LiDAR 120. In the LiDAR image processing technology, the semantic segmentation can find and use meaningful information from LiDAR data for object recognition and scene reproduction, for implementing autonomous driving. Various semantic segmentation AI models can be used, such as a projection-based method, a point-based method, and a sparse convolution-based method. For example, the semantic segmentation result may be the result of AI computation performed by the processor 110 and NVIDIA DRIVE™ AGX system. With this configuration, for example, various annotations, such as colors, may be added to the LiDAR point cloud image.

After the segmentation process as above, the LiDAR image can undergo a post-processing process. The post-processing can involve converting point cloud data into a 3D map or a model, which can be meaningful information for autonomous driving. The post-processing can also include a process of removing noise and errors from a LiDAR point cloud image, recognizing an object such as a vehicle or a pedestrian from the point cloud, and attaching and registering a unique identifier to point cloud information as necessary.

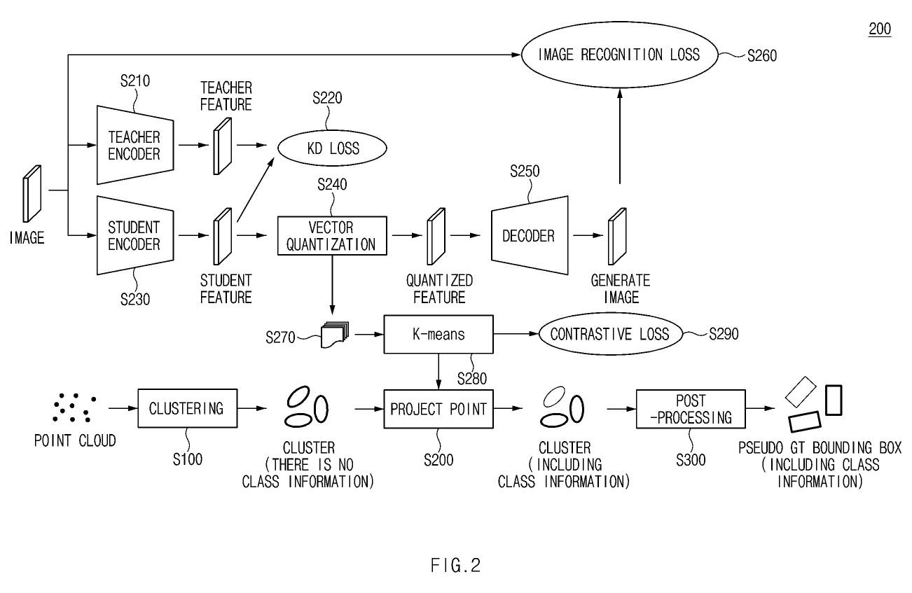

Next, FIG. 2 is a block diagram showing an example of an overall algorithm 200 for labeling unlabeled point cloud data and generating a pseudo GT bounding box including class information, according to an implementation of the present disclosure.

An AI module according to an implementation of the present disclosure may be mounted on the processor 110, and more broadly, may operate as a part of a computing system 1000 or in a cloud method.

Referring to FIG. 2, in S100, an AI module according to an implementation of the present disclosure receives point cloud data from the LiDAR sensor 120 and performs segmentation processing. For example, as described above, in S100, point clouds can be clustered into specific groups to prepare for P-Box generation. In some scenarios, cluster expansion can be performed. Here, an expansion target may include a cluster that is expanded to include all points within a given distance from the seed point plus an additional incremental distance epsilon (where the given distance constitutes the unexpanded cluster).

During the segmentation processing, P-Box creation and clustering based on the point cloud are performed. For example, the AI network performing segmentation is used to obtain a point label from the LiDAR sensor 120.

In S200, a mapping table can be generated for mapping between features and classes by using cluster information of image features extracted by a trained image encoder. Also, point classes can be assigned by projecting the point cloud onto an image plane using extrinsic parameter and intrinsic parameter. The extrinsic parameter includes a parameter regarding rotation and translation between coordinate system(x,y,z) of LiDAR sensor and coordinate system(x,y,z) of camera. The intrinsic parameter includes a parameter regarding conversion between coordinate system(x,y,z) of camera and coordinate system(u,v) of image plane of camera(e.g., focal length, principal point, skew coefficient).

Post-processing is performed in S300. As mentioned above, a LiDAR image goes through clustering and other segmentation processes in S100 and goes through post-processing in S300. The post-processing can involve converting point cloud data into a 3D map or a model, which can be meaningful information for autonomous driving. The post-processing can also include a process of removing noise and errors from a LiDAR point cloud image, recognizing an object such as a vehicle or a pedestrian from the point cloud, and attaching and registering a unique identifier to point cloud information as necessary. As such, results in a form of a predicted bounding box (i.e., P-Box) may be output by applying the post-processing technique of S300 to the cluster generated through S220. Moreover, according to implementations of the present disclosure, a predefined pattern (pattern matching) can be utilized to ensure P-Box consistency (e.g., Ground Contact Constraint).

Another feature in S300 of FIG. 2 that differs from alternative post-processing techniques is to indicate that the above-described pseudo-GT bounding box is generated as an output. In this case, a rule-based clustering method can be used. In some implementations, the data utilized for GT generation in S300 can be include time-synchronized sensor data (e.g., synced image-point cloud pair) and information related to camera-LiDAR mutual adjustment (which can be set in advance).

Referring again to S200 in FIG. 2, in some implementations, the point projection process of S200 can be performed by an AI module that undergoes self-supervised learning. An example of self-supervised learning is shown in S210 to S290 of FIG. 2.

In this example, the training process according to an implementation of the present disclosure can be performed to generate a pseudo GT bounding box. In some scenarios, this may be subdivided into different processes, such as three processes including (i) object detection, (ii) image feature extraction, and (iii) auto labeling, which are described next.

(i) Object detection can include ground estimation for distinguishing between ground and non-ground and a procedure of removing unnecessary points, and also a procedure of clustering a plurality of LiDAR point clouds depending on the above-described criteria for object recognition. For example, an algorithm can be performed to estimate points corresponding to the ground from original point cloud data input from the LiDAR sensor 120. In the case, a pre-trained deep learning-based model or a rule-based model using a normal vector may be utilized. For example, the rule-based methodology according to an implementation of the present disclosure first calculates the normal vector of a point cloud, converts points into a reference coordinate system by using the calculation result, and performs AI inference on the ground and non-ground by combining a height (i.e., z value) and an average value of the normal vector.

In the case of a clustering procedure during object detection, e.g., clustering of points in S100, implementations of the present disclosure may apply an unsupervised learning-based AI algorithm capable of extracting a cluster from the point cloud. In autonomous driving situations, the number of recognized objects is variable, and thus a density-based clustering algorithm can be used, e.g., rather than K-Nearest Neighbor (KNN). For example, when clusters related to 3D objects are built based on the density of points by using a 3D Density-Based Spatial Clustering of Applications with Noise (DBSCAN) clustering algorithm, data structures regarding points and grid trees can be used. The dynamic number of clustering is possible when the DBSCAN is applied. 3D classification tools such as POINTNET^{™} (source: https://github.com/charlesq34/pointnet) may also be utilized when the DBSCAN is applied. Moreover, as in S220 of FIG. 2, the algorithm may include a Knowledge Distillation (KD) tree structure.

(ii) Image feature extraction can be performed, for example, by self-supervised learning involving an encoder that extracts latent features from image data, a decoder that attempts to reconstruct the image from the latent features, and a loss-based learning algorithm that seeks to learn the loss-optimizing latent features. In addition, K-Means clustering S280 in parallel with contrastive learning S290 can be performed to cluster the latent features into different classes. When image features are extracted, a procedure of self-supervised learning and vector quantization S240 can be included.

More specifically, the image feature extraction according to an implementation of the present disclosure goes through a pre-training process. In this case, the AI self-supervised learning algorithm is applied to reconstruct the image as shown in FIG. 2. This process can obtain class information from an image obtained in synchronization with the point cloud.

As illustrated in FIG. 2, the training image is input to a teacher encoder and a student encoder in S210 and S230, respectively. The teacher network is a pre-trained network, and the trained knowledge can be transferred to the student network as shown. Outputs of S210 and S230 become latent features. Afterwards, the feature quantized through vector quantization in S240 is input to a decoder in S250, and the decoder attempts to reconstruct an image that is similar to an original data. As in S220, knowledge distillation (KD) loss occurs in the computational results between a high-performance teacher network and a student network, as the performance of the student network is generally lower than the performance of the teacher network.

For example, teacher and student models with the same structure can be generated in S210 and S230, and the loss function is set in S220 such that the output distribution of the student model becomes similar to that of the teacher model.

In AI learning, training through performance evaluation and feedback can be implemented, for example to transfer knowledge from the teacher network to the student network. In an implementation of the present disclosure, an image reconstruction loss technique is applied in S260 for training of an encoder and a decoder. A L2 loss function such as a Variational Auto Encoder (VAE), a similarity-based loss function considering similarity, and a Generative Adversarial Network (GAN) loss functions with an added discriminator may be considered as loss functions for AI learning that are capable of being applied to S260. In some implementations, a model undergoing the primary learning may be used, or may be trained based on direct driving data when sufficient image data for a driving scenario is secured. However, in some scenarios, this learning process does not require GT data other than the original data.

Secondary learning related to image feature extraction is performed by a K-means clustering technique of S280. Secondary learning can be applied to train the student network on how to cluster the latent features. Then, the latent features can be assigned to classes, to provide a feature-class mapping that can be applied in S200 to assign class information to clusters of points. In this case, clustering of the features can involve performing clustering with contrastive learning. The model undergoing the primary learning may extract features capable of expressing images well. However, because the extracted features are in a form of high-dimensional vectors, there may be limitations in the discrimination power between different class features. Accordingly, implementations of the present disclosure can perform K-means clustering on latent features, which is obtained by performing K-means clustering with Contrastive Learning, to improve the discrimination power between features by the number of classes required for object detection.

For reference, the K-means is an unsupervised learning technique of machine learning that performs clustering by using ‘K’ clusters. Here, an average (i.e., means) refers to an average distance between the center of each cluster and pieces of data. Accordingly, when the K-means clustering is applied in S280, latent features are split into ‘K’ groups. The Top-N of each group (i.e., ‘N’ latent vectors in an order close to the cluster center) are selected, and ‘N’ vectors within each group become similar to each other. On the other hand, contrastive learning is applied to make vectors belonging to different groups different from each other.

The K-means clustering of S280 may be used together with self-supervised learning through image reconstruction performed in the primary learning. Moreover, in some scenarios for computational efficiency, the K-means clustering may be performed and updated periodically rather than being performed every time. After the secondary learning is completed, a mean vector corresponding to a specific class may be specified by analyzing the results of the K-means clustering. However, in some implementations, this process is performed manually and only needs to be done once.

In some scenarios, implementations of the present disclosure may also apply advanced image feature extraction. In this case, a Distillation with No Label (DINO) technique is applied in parallel with vector quantization of S240. For reference, in addition to a basic learning technique (e.g., image reconstruction learning) set in the primary learning stage, it is possible to apply various self-supervised learning techniques. In particular, when semantic features are extracted, a DINO-based image encoder may be trained by using a KD loss technique, such as S220.

Additionally, as described above, the vector quantization of S240 may be applied to induce image features to be more clearly identified. The image reconstruction loss series may be used as a loss function applied to S240. Finally, as shown in FIG. 2, the quantization vector corresponding to the latent feature may be obtained by using the student encoder of S230 and a codebook of S270. In this case, the latent features used in the secondary learning (K-means clustering and contrastive learning) described above are replaced with quantized vector data.

Learning may be done by using the VAE and GAN techniques described above in a method of mapping features into categorized vectors, not continuous vectors, by using the codebook of S270.

(iii) The auto labeling is performed by using an image-point cloud projection module and through tuning. That is, when there is a cluster of points without class label information despite passing through S100 in FIG. 2, the cluster of points is received, and the auto labeling is performed through a point projection process S200.

On the basis of the above descriptions, the image-point cloud projection process in S200 is further described as follows. That is, S200 may correspond to a kind of calibration process. The extracted latent feature is projected and matched to express a specific class by using the most similar K-means vector. It is possible to know where an arbitrary point is projected on an image, when extrinsic parameters of a camera and the LiDAR 120 and intrinsic parameters of the camera are used.

In S200, a class can be matched to a point, for example, by specifying a class that matches the latent feature at a location, onto which the point is projected, as the class of the corresponding point. For each cluster of points, a class with the most points is selected as the class of the corresponding cluster of points (a type of majority voting technique). Accordingly, the class of all points included in the corresponding cluster is replaced with the class classification result based on a majority vote.

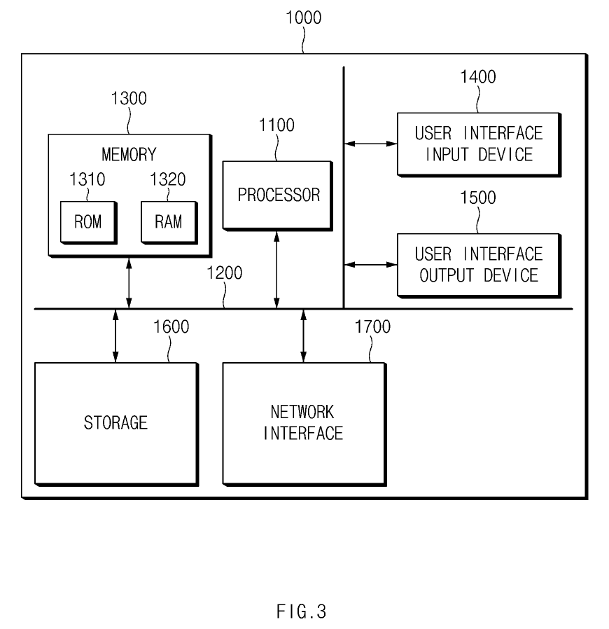

FIG. 3 is a block diagram showing a computing system 1000 for autonomous vehicle control and object recognition operations, according to an implementation of the present disclosure.

Referring to FIG. 3, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the implementations disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and variations may be made by one skilled in the art without departing from the essential characteristic of the present disclosure.

Accordingly, implementations of the present disclosure are intended not to limit but to explain the technical idea of the present disclosure, and the scope and spirit of the present disclosure is not limited by the above implementations. The scope of protection of the present disclosure should be construed by the attached claims, and all equivalents thereof should be construed as being included within the scope of the present disclosure.

Through the detailed description of the present disclosure and the attached drawings, those skilled in the art may understand various effects other than the effects described above from the present disclosure.

Hereinabove, although the present disclosure was described with reference to exemplary implementations and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An artificial intelligence (AI)-based system configured to perform object recognition, the system comprising:
at least one processor; and
at least one memory storing computer program instructions that, based on being executed by the at least one processor, perform operations of recognizing an object in a surrounding environment based on at least one autonomous driving sensor, the operations comprising:
obtaining an image from the at least one autonomous driving sensor, and extracting at least one latent feature from the image, based on a result of a first self-supervised learning process;
for each latent feature among the at least one latent feature, assigning a class to the latent feature based on a result of a second self-supervised learning process;
obtaining point cloud data from the at least one autonomous driving sensor, and clustering the point cloud data to generate a cluster of points;
for each point in the cluster of points, determining a corresponding latent feature among the at least one latent feature;
assigning a matching class to the cluster of points based on a correspondence between classes assigned to the latent features and points in the cluster of points; and
generating a pseudo ground-truth (GT) bounding box for the cluster of points, based on the matching class.

2. The system of claim 1, wherein the at least one autonomous driving sensor includes at least one LiDAR and a camera.

3. The system of claim 1, wherein the first self-supervised learning process comprises:
encoding a training image through an encoder to convert the training image into the at least one latent feature; and
decoding the at least one latent feature through a decoder to generate a reconstructed image.

4. The system of claim 3, wherein the encoder includes a teacher encoding network and a student encoding network, and a knowledge distillation (KD) loss function is applied such that an output of the student encoding network is similar to an output of the teacher encoding network.

5. The system of claim 3, wherein at least one of a L2 loss function including a variational auto encoder (VAE), a similarity-based loss function, or a Generative Adversarial Nets (GAN) loss function, to which a discriminator is applied, is implemented as a loss function for the first self-supervised learning process of generating the reconstructed image.

6. The system of claim 1, wherein the image obtained from the at least one autonomous driving sensor does not include a label related to a GT bounding box.

7. The system of claim 3, wherein the second self-supervised learning process includes performing K-Means clustering and contrastive learning to enhance discrimination power of the at least one latent feature, in parallel with the first self-supervised learning process.

8. The system of claim 7, wherein the K-Means clustering is executed periodically and is updated.

9. The system of claim 8, wherein the matching class is determined by using a K-Means vector that is most similar to the latent feature.

10. The system of claim 2, wherein the assigning of the matching class includes:
assigning a plurality of temporary classes to the points in the cluster of points by using an external or internal parameter of the LiDAR and the camera, and
determining a temporary class, among the plurality of temporary classes, which is assigned to the most points in the cluster of points, as the matching class.

11. A method for performing artificial intelligence (AI)-based object recognition based on at least one autonomous driving sensor, the method comprising:
obtaining an image from the at least one autonomous driving sensor, and extracting at least one latent feature from the image, based on a result of a first self-supervised learning process;
for each latent feature among the at least one latent feature, assigning a class to the latent feature based on a result of a second self-supervised learning process;
obtaining point cloud data from the at least one autonomous driving sensor, and clustering the point cloud data to generate a cluster of points;
for each point in the cluster of points, determining a corresponding latent feature among the at least one latent feature;
assigning a matching class to the cluster of points based on a correspondence between classes assigned to the latent features and points in the cluster of points; and
generating a pseudo ground-truth (GT) bounding box for the cluster of points, based on the matching class.

12. The method of claim 11, wherein the at least one autonomous driving sensor includes at least one LiDAR and a camera.

13. The method of claim 11, wherein the first self-supervised learning process comprises:
encoding a training image through an encoder to convert the training image into the at least one latent feature; and
decoding the at least one latent feature through a decoder to generated a reconstructed image.

14. The method of claim 13, wherein the encoder includes a teacher encoding network and a student encoding network, and a KD loss function is applied such that an output of the student encoding network is similar to an output of the teacher encoding network.

15. The method of claim 13, wherein at least one of a L2 loss function including a VAE, a similarity-based loss function, or a GAN loss function, to which a discriminator is applied, is implemented as a loss function for the first self-supervised learning process of generating the reconstructed image.

16. The method of claim 11, wherein the image obtained from the at least one autonomous driving sensor does not include a label related to a GT bounding box.

17. The method of claim 13, wherein the second self-supervised learning process includes performing K-Means clustering and contrastive learning to enhance discrimination power of the at least one latent feature, in parallel with the first self-supervised learning process.

18. The method of claim 17, wherein the K-Means clustering is executed periodically and is updated.

19. The method of claim 18, wherein the matching class is determined by using a K-Means vector that is most similar to the latent feature.

20. The method of claim 12, wherein the assigning of the matching class includes:
assigning a plurality of temporary classes to the points in the cluster of points by using an external or internal parameter of the LiDAR and the camera, and
determining a temporary class, among the plurality of temporary classes, which is assigned to the most points in the cluster of points, as the matching class.
